(19) United States
(12) Patent Application Publication
(10) Pub. No.: US 2002/0069090 A1
(43) Pub. Date: Jun. 6, 2002

(54) Insurance business system

(76) Inventors: Kurt M. De Grosz, Burlingame, CA (US); Brian W. Bair, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/917,287

(22) Filed: Jul. 27, 2001

Related U.S. Application Data
(60) Provisional application No. 60/251,754, filed on Dec. 5, 2000.
(60) Provisional application No. 60/251,703, filed on Dec. 5, 2000.
(60) Provisional application No. 60/251,708, filed on Dec. 5, 2000.

(51) Int. Cl. G06F 17/60

(52) U.S. Cl. 705/4

(57) ABSTRACT

The present invention provides systems and methods for the employee benefits industry. The system includes a client management module for providing a broker with one or more broker tools for generating an employer record and employee record. The system also includes a presale module coupled to the client management module for providing the broker with one or more workflow tools, which enable a request for proposal (RFP), electronic submission of the RFP to an insurance carrier and receiving a response to the RFP. The system also includes an enrollment and benefits administration module coupled to the client management module for providing the employer with a set of employer tools for benefits administration for the employee and for processing a benefit product for the employee. The system includes a system database for storing the employer record and the employee record.

### CROSS-REFERENCES TO RELATED APPLICATIONS

This application claims priority to U.S. patent application Ser. No. 09/714,896, which was filed Nov. 15, 2000 and U.S. Provisional Application Nos. 60/251,754, 60/251,754, 60/251,703 and 60/251,708 all of which were filed on Dec. 5, 2000, the disclosures of each of foregoing applications are hereby incorporated by reference in their entireties for all purposes.

### BACKGROUND OF THE INVENTION

Healthcare is a $900 billion to 1 trillion dollar market characterized by tremendous inefficiencies that account for upwards of $250 billion in unnecessary expenditures. The employee benefits industry is dominated by a highly inefficient distribution system. A paper-based, labor-intensive distribution process contributes to health plan expense ratios that often exceed 20% of premiums. Long sales cycles, redundant data entry, and excessive paper handling results in inaccurate case installations, poor customer service and, ultimately, low customer satisfaction and retention.

The healthcare and insurance industries have done little to correct these inefficiencies. Several factors explain this inaction. First, the insurance industry historically has placed more emphasis on pricing than cost cutting in determining profitability, hence decades of hard and soft market cycles. Second, insurer focus on propriety has resulted in isolated legacy systems and a lack of product and electronic standards, hence an industry that is much less automated than other service industries such as financial services. Third, insurers have been reluctant to push change on the broker distribution channel for fear of alienating the very entities that control the local, relationship-based healthcare insurance business.

These challenges are attracting billions of dollars from people and businesses that view healthcare and insurance as vertical markets ripe for radical transformation. Generally, the first movers in this space have focused on one of three main areas: creating an electronic insurance marketplace (e.g., InsWeb, InsureMarket, ChannelPoint, eHealthinsurance, Quotesmith), developing benefits administration solutions (e.g., Healtheon, Employease, Bentana, BisNet), or delivering employee communication tools and content (e.g., Authoria, Enwisen, Workscape) The entities creating an electronic insurance marketplace focus primarily on individual products, including auto, home, life, and health. Some, like InsWeb and ChannelPoint, focus on small group as well. Whereas non-complex, commodity insurance products make sense for direct distribution over the web, more complex products such as those that make up a typical group benefits package, will continue to require the involvement of an intermediary or consultant. The entities developing benefits administration solutions in order to simplify employee communications and eligibility maintenance, are attacking the symptoms and not the source of the problems. As mentioned above, the source of the problems of high costs, inaccuracies, and poor customer service, is the distribution process itself. The entities delivering just employee communication tools and content are not associated with or linked to transactions, and therefore are at risk of losing out to product distribution entities that can deliver content and employee communication tools integrated with the transaction and distribution processes.

There is a need to solve distribution challenges by developing a platform that supports the broker/consultant distribution channel. A solution broadly adopted by the broker distribution channel will quickly capture dominant market share and facilitate industry transformation. Moreover, there is a need to implement a system wherein the carrier, the broker, the employer and employee are connected in an efficient streamlined process. The present invention fulfills these and other needs.

### SUMMARY OF THE INVENTION

The present invention provides systems and methods which are highly efficient and rectify the paper-based, labor-intensive distribution process that contributes to health plan expense ratios that often exceed 20% of premiums. As such, in one embodiment, the present invention provides a system for the employee benefits industry. The system includes a client management module (or customer service module) for providing a broker with one or more broker tools for generating an employer record and an employee record. The system also includes a presale module coupled to the client management module for providing the broker with one or more workflow tools, which enable a request for proposal (RFP), electronic submission of the RFP to an insurance carrier and receiving a response to the RFP. The presale module also includes renewal functionality that allows the broker to organize upcoming plan renewals and submit electronic renewal requests to an insurance carrier and receiving a response to that renewal request. The system also includes an enrollment and benefits administration module coupled to the client management module for providing the employer with a set of employer tools for enrollment and benefits administration and for processing a benefit product or eligibility change for the employee. The system also includes a system database for storing the employer record and the employee record, and as included in an activity log, the broker can record phone calls and record issues for their employers.

The system further includes an eligibility and billing module to allow for the consolidation and production of a single bill for premiums and transmission of eligibility to carriers. In other preferred aspects, the system further includes a worksite marketing module to enable distribution of ancillary benefit products such as, additional employee benefits and financial products and services relating to enrollment, life events and retirement.

In another embodiment, the present invention provides a method for procuring a benefit product in a networked environment. The method includes providing a broker with a set of workflow tools enabling a request for proposal (RFP) and renewal of the benefit product to an insurance carrier and receiving a response from the insurance carrier of the RFP. The method includes providing an employer with a set of employer tools for administration of the benefit product for an employee. The method also includes enrolling the employee in the benefit product offered by the insurance carrier, thereby procuring the benefit product in a networked environment. Preferably, the set of workflow tools further comprises a renewal functionality, which allows the broker to organize upcoming plan renewals and submit an electronic renewal request to an insurance carrier and receive a response to the electronic renewal request.

Numerous benefits are achieved by way of the present invention over conventional techniques. For example, the present invention provides efficient computer implemented systems and methods to replace the labor-intensive distribution process that contributes to health plan expense ratios that often exceed 20% of premiums. The prior art systems and methods, which are dominated by long sales cycles, redundant data entry, and excessive paper handling, are replaced with the present computer implemented systems and methods. Moreover, the systems and methods of the present invention provide key business intelligence through data mining of clean, comprehensive data enabling targeted marketing campaigns, efficient distribution of products, quantification of acquisition costs, and the like.

Various additional objects, features and advantages of the present invention can be more fully appreciated with reference to the detailed description and accompanying drawings that follow.

### BRIEF DESCRIPTION OF THE DRAWINGS

FIG. 1A is a simplified diagram of a networked environment for the employee benefits industry according to an embodiment of the present invention;

FIG. 1B is a diagram of one embodiment of a networked environment for the employee benefits industry according to an embodiment of the present invention;

FIG. 2 is a simplified diagram of computing modules for processing information according to an embodiment of the present invention;

FIG. 3 is a simplified diagram of a computer platform for processing information according to an embodiment of the present invention;

FIG. 4 is a simplified flow diagram for systems and methods according to embodiments of the present invention;

FIG. 5 is a simplified flow diagram for systems and methods according to embodiments of the present invention;

FIG. 6 is a simplified flow diagram for systems and methods according to embodiments of the present invention;

FIG. 7 is a simplified flow diagram for systems and methods according to embodiments of the present invention;

FIG. 8 is a simplified flow diagram for systems and methods according to embodiments of the present invention; and

FIG. 9 is a simplified diagram of an analytics module according to one embodiment to the present invention.

### DETAILED DESCRIPTION OF THE INVENTION AND PREFERRED EMBODIMENTS

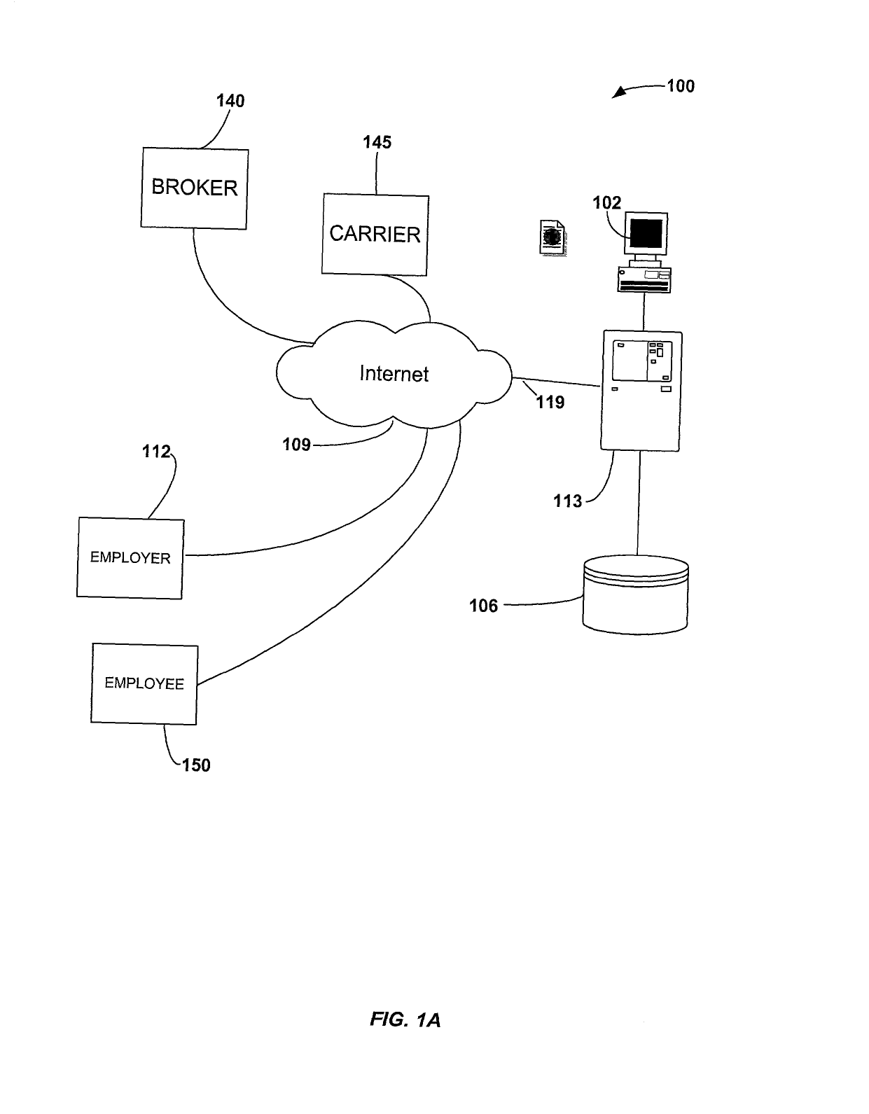

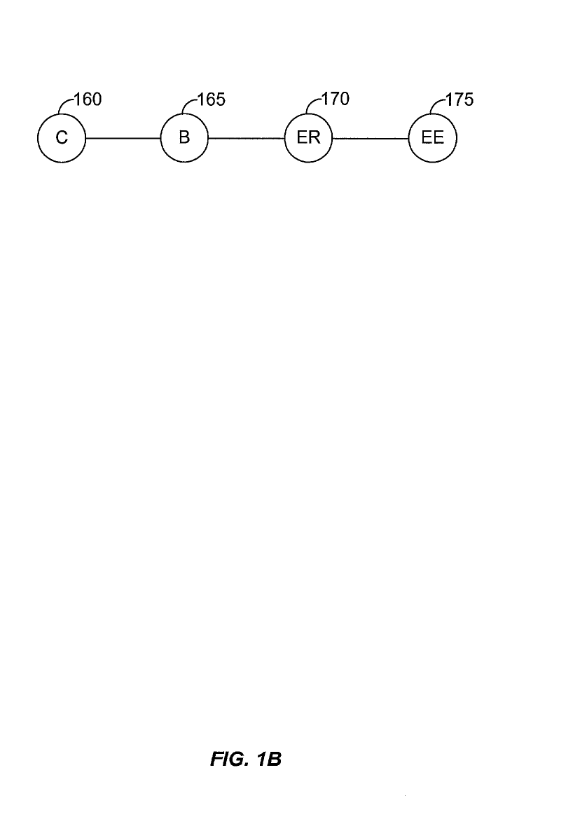

FIG. 1A is a simplified networked environment diagram 100 according to an embodiment of a system for the employee benefits industry of the present invention. This diagram is merely an example, which should not limit the scope of the claims herein. One of ordinary skill in the art would recognize many other variations, modifications, and alternatives. As illustrated therein, the system 100 includes a variety of elements such as a wide area network 109 such as, for example, the Internet, an intranet, or other type of network. Connected to the wide area network 109 is an information server 113, with terminal 102 and database 106. The wide area network allows for communication of other computers such as a client unit 112, broker 140 and carrier 145. Clients can be configured with many different hardware components and can be made in many dimensions, styles and locations (e.g., laptop, palmtop, pen, server, workstation and mainframe).

Terminal 102 is connected to server 113. This connection can be by a network such as Ethernet, asynchronous transfer mode, IEEE standard 1553 bus, modem connection, universal serial bus, and the like. The communication link need not be a wire but can be infrared, radio wave transmission, and the like. Server 113 is coupled 119 to the Internet 109. The Internet is shown symbolically as a cloud or a collection of server routers, computers, and other devices 109. The connection to server is typically by a relatively high bandwidth transmission medium such as a T1 or T3 line, but can also be others.

In certain embodiments, Internet server 113 and database 106 store information and disseminate it to computers e.g., 112, 140, 145, 150 over wide area network 109. The concepts of “client” and “server,” as used in this application and the industry, are very loosely defined and, in fact, are not fixed with respect to machines or software processes executing on the machines. Typically, a server is a machine e.g., 113 or process that is providing information to another machine or process, i.e., the “client,” e.g., 140 that requests the information. In this respect, a computer or process can be acting as a client at one point in time (because it is requesting information) and can be acting as a server at another point in time (because it is providing information). Some computers are consistently referred to as “servers” because they usually act as a repository for a large amount of information that is often requested. For example, a WEB site is often hosted by a server computer with a large storage capacity, high-speed processor and Internet link having the ability to handle many high-bandwidth communication lines.

In a specific embodiment, the network is also coupled to broker 140 using a computer to connect to the server 113 over the Internet by accessing a Web site associated with the system 100. The main system application runs on the server 113. Similarly, an insurance carrier 145 uses a computer to connect to the system 100 over the Internet by accessing the same Web site. A Web browser running on the computer accesses the Web site. Preferably, the Web browser is either the Microsoft Internet Explorer™ Web browser, or the Netscape Navigator™ Web browser. It is understood that the broker 140 is an individual who works for an insurance brokerage firm or for an insurance consulting firm, or who is providing insurance brokerage or consulting services in an individual capacity, so that the term broker 140 includes both insurance brokers and insurance consultants, regardless of the specific type of business organization they operate under. Thus, as used herein, the term “broker” will include both traditional brokers and consultants unless otherwise stated. The carrier 145 is an individual who works for an insurance carrier or provider. The broker 140 and the carrier 145 do not need to be connected to the system 100 at the same time. The system 100 also preferably includes an employer 112 and employee 150.

FIG. 1B shows a preferred embodiment of the connectivity of the system network. Advantageously, using the systems and methods of the present invention, broker 165 similar to broker 140 in FIG. 1A, can increase revenues, lower costs, and improve customer service and retention using the present invention. An efficient system is generated wherein a broker 165 is able to target more products and services to an employee 175 via employer 170 in an efficient workflow environment. Broker 165, carrier 160, employer 170 and employee 175 operate in a streamline workflow process. Moreover, brokers 160 improve customer service and retention as the systems and methods assure accuracy and accessibility of information.

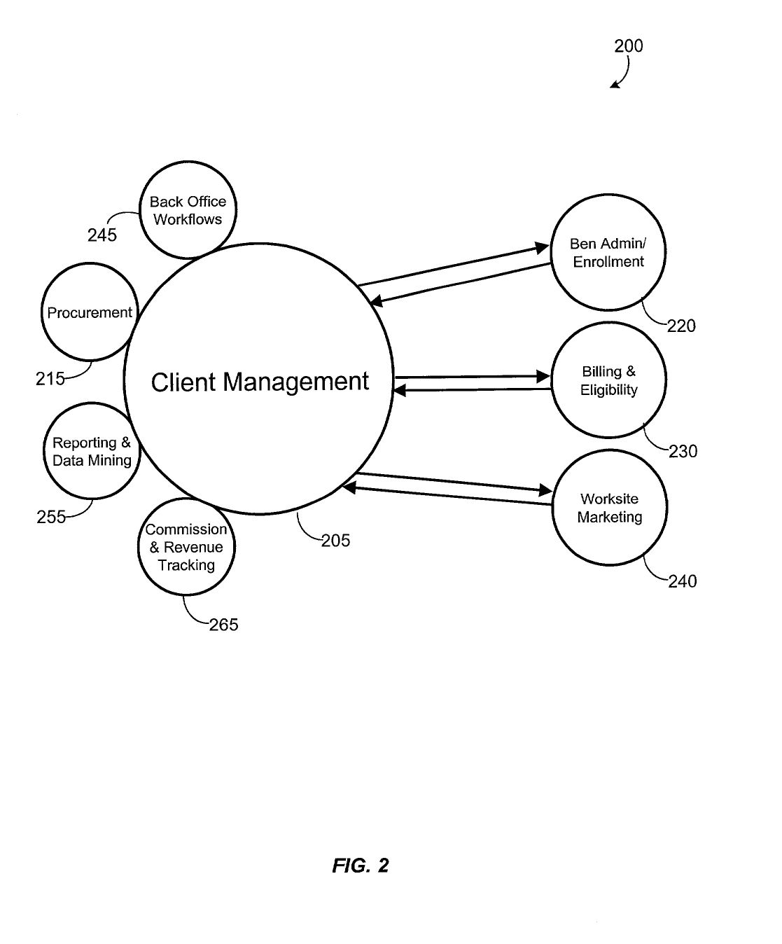

FIG. 2 is a simplified diagram of a system 200 for the employee benefits industry according to an embodiment of the present invention. This diagram is merely an example, which should not limit the scope of the claims herein. One of ordinary skill in the art would recognize many other variations, modifications, and alternatives. A main application runs on the application server such as the server 119 in FIG. 1A. The main application includes a plurality of modules, including a customer service or client management module 205, a presale or procurement module 215, a benefits administration and enrollment module 220, a billing and eligibility module 230 and a worksite marketing module 240. In certain aspects, additional modules are operating including, but not limited to, a back office workflow module 245, a reporting and data mining (analytics) module 255 and a commission and revenue tracking module 265. Preferably, the main application is written in Java™ programming language. Each of the foregoing modules are explained in detail below.

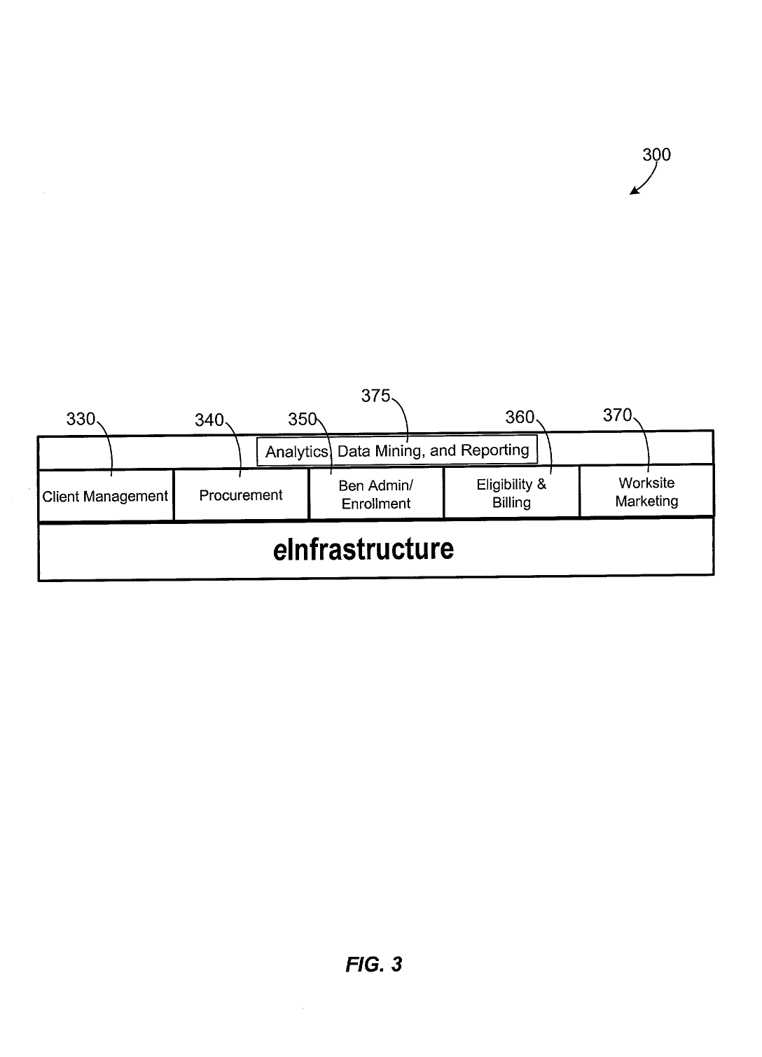

FIG. 3 is a simplified diagram of a system 300 for the employee benefits industry according to an embodiment of the present invention. This diagram is merely an example, which should not limit the scope of the claims herein. One of ordinary skill in the art would recognize many other variations, modifications, and alternatives. Similar to system 200, system 300 illustrates a preferred embodiment of the systems and methods of the present invention having a broker centric system platform.

The systems and methods of the present invention provide a client or customer service management module 330. The client management module enables on-line setup of benefit products, migration data from legacy systems, and the like. Various reports can be generated including, but are not limited to, account information listings, plan information listings, mail merges, (e.g., for account contact information), client completeness summary reports, and client completeness detail reports.

The systems and methods of the present invention provide a presale module coupled to the client management module for providing the broker with one or more workflow tools, which enable a request for proposal (RFP), electronic submission of the RFP to an insurance carrier and receiving a response to the RFP. Advantageously, the insurance carrier and broker can negotiate the terms of the RFP on-line. The workflow tools comprise an installation tool for installing customers onto the system in which the employee, employer, carrier and broker can access. In certain preferred aspects, the workflow tools enable ongoing customer service. Most benefit brokers and consultants do not have a customer service platform; rather, they work out of paper files and spreadsheets that quickly become outdated. The systems and methods of the present invention dramatically improve the ability of brokers to provide customer service by giving brokers the tools to collect, manage and access data on their clients.

In certain aspects, the presale module enables an RFP. One embodiment of a suitable request for proposal (RFP) process is set forth in detail in U.S. patent application Ser. No. 09/714,896, filed Nov. 15, 2000, which is assigned to the present assignee and the teachings of which are hereby incorporated by reference in their entirety for all purposes. In general, the RFP functionality automates the creation, transmission and management of RFPs and purchase plans. As described therein, the RFP process includes the steps of completing general bid instructions, completing a risk questionnaire, completing an employee census, claims history and rate history, adding one or more plans on which bids are desired to the RFP, and then notifying the insurance carrier by e-mail that the RFP is ready for review. The system allows a broker to create an online questionnaire and add to an RFP for the carrier to answer online. The broker can compare all carrier responses via a comparison tool and incorporate into an employer report. The carrier reviews and responds to the RFP by accessing the Web site with a login that permits the carrier to view that specific RFP. Alternatively, the RFP can be faxed or e-mailed to the carrier for review, such as when the carrier is not authorized to access the Web site.

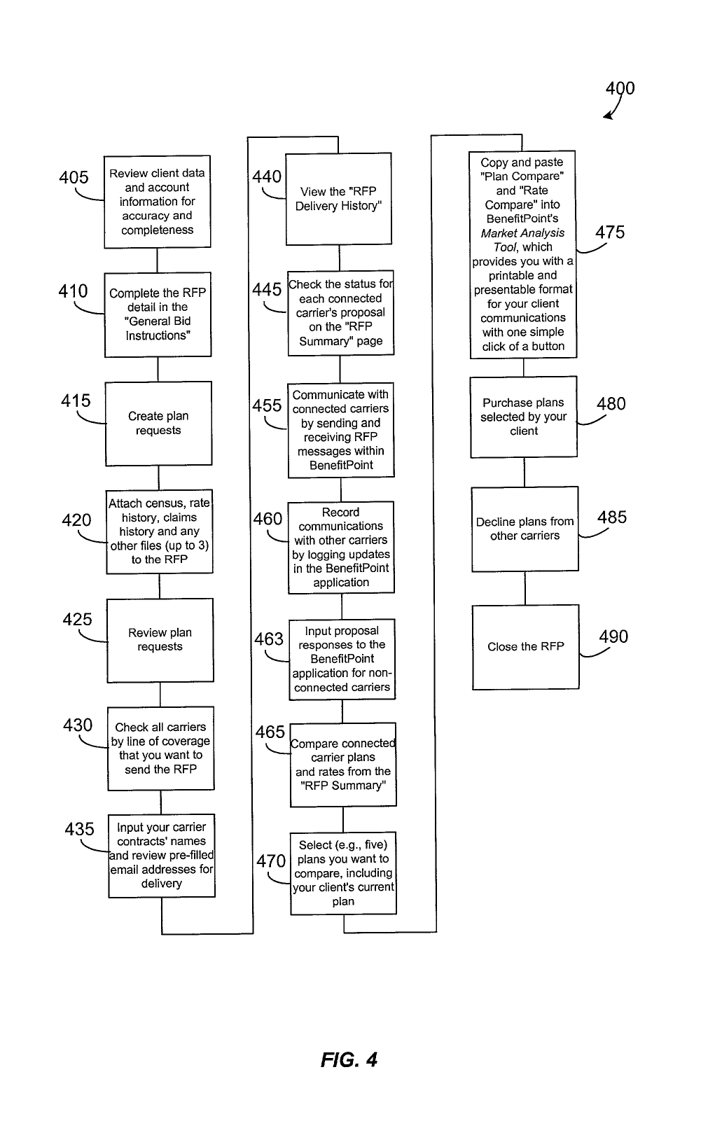

FIG. 4 illustrates a flow diagram 400 representing a RFP checklist for brokers for one embodiment of the present invention. One of ordinary skill in the art would recognize many other variations, modifications, and alternatives.

In step 405, the broker, like the broker 140 in FIG. 1A, reviews client (employer) data and account information for accuracy and completeness. This can include, for example checking account information, viewing an account team's contacts, reviewing current plans, rates, commissions and contributions, confirming census, rate history, claims history information and the like. Account information generally includes for example, the company name, business type, industry, website address, number of full-time employees as of a certain date, eligibility rules, locations, divisions, classes, payroll cycle, year the company was established and the names of affiliates and subsidiaries. Address information includes the main street address for the company, the billing address and the mailing address for the company. Primary contact information includes information about the person who should be contacted at the company to discuss employee health benefit plans, including the name, title, street address, phone and fax numbers and e-mail address for the primary contact(s).

In step 410, the RFP's “General Bid Instructions” is completed. In certain aspects, an RFP objective (e.g., similar to a cover letter) can be added. This may include for example, the RFP client contact(s) information, as well as the proposal due date and effective date is filled-in and completed. This step can also include completing the “Risk Questionnaire”. General Bid Instructions include for example, information such as the RFP objective; RFP contact information; a proposed effective date; a due date; the funding methods for requested plan types; and other information such as questions and instructions, e.g., if domestic partner coverage is desired, commission information, benefit variations by class, retiree eligibility and union groups eligibility, and the like. The Risk Questionnaire information can include for example, the diagnosis, date of diagnosis and amount of claims paid to date about employees (potential insured) who have been diagnosed with, or are being treated for, certain conditions such as cancer, heart disease, stroke, kidney disorders or immune system disorders.

In step 415, the broker creates a plan request. In certain aspects, this involves selecting plan types and carriers for marketing. In another aspect, this involves creating additional bid instructions. Next, the broker attaches 420 a census of the client. In addition, a rate history, claims history and any other files (e.g., 3 files) to the RFP can be included.

A typical employee census attachment comprises a spreadsheet with columns that may include for example, employee ID number, last name, first name, gender, home zip code, date of birth, city of residence and state (all for the employee). The census data can also include employee status (e.g. active, retired, COBRA), class, division, work site location, date of hire, title, worker's comp code, annual salary, annual commissions, annual bonuses, marital status, dependent status and domestic partner status (all for the employee).

In step 425, the broker reviews a plan request. The broker then checks 430 all carriers by line of coverage that the RFP is to be sent. Next, the broker inputs 435 the carrier contacts' names and optionally reviews pre-filled e-mail addresses for delivery. Thereafter, in step 440, the “RFP Delivery History” can be reviewed. In a preferred embodiment, an RFP is delivered to multiple carrier contacts at multiple carrier offices. In certain aspects, the system updates the “RFP Delivery History” once an RFP is sent to the carriers.

In step 445, the broker checks the status for each connected carrier's proposal on the “RFP Summary” page. In certain aspects, the broker can search the system Product Library to find a closely matched plan to the proposal that is received. In addition, the broker can add a plan and make any revisions to exactly match the carrier's proposal. In a preferred embodiment, a plan is added to the RFP by a broker by selecting a plan from a product library, and then modifying the attributes (if necessary) to reflect the desired policy coverage. Also in certain aspects, the broker can market an employer's current plans by copying over all benefit attributes of a current plan into a requested plan and then adding that plan to the RFP.

In general, the product library is a database like database 106 in FIG. 1A, comprised of a plurality of product plans. Each product plan represents a group insurance plan. The product library includes product plans for many carriers across many plan types and many lines of coverage. A representative product library can contain hundreds of plans. The information in the product plans contained in the product library can be collected and input into a plan.

The broker can then enter in the rates submitted by non-connected carrier. Connected carrier rates are in the RFP after the carrier has quoted. If the broker then saves this information, the request is moved to “Quoted” for non-connected carriers. Preferably, the carriers connected to the system will receive an e-mail with the URL link to review the RFP and respond online via the system of the present invention. Other carriers will receive an e-mail with all RFP attachments and will respond by for example, fax, e-mail, mail, and the like.

In step 455, the broker can communicate with connected carriers by sending and receiving RFP messages within the system. The communication with other carriers can be recorded 460 by logging updates in the system application. In preferred aspects, the system date and time stamps and thereafter logs the communication. The broker inputs 463 proposal responses into the system application for non-connected carriers.

The broker can then compare 465 the connected and non-connected carrier plans and rates from the “RFP Summary” that is generated. The broker can then select 470 various plans (e.g., five) to compare, including in preferred aspects, the client's current plan. In step 475, the broker can copy and paste the “Plan Compare” and “Rate Compare” features into the application's Market Analysis Tool, which provides a printable and presentable format for client communications. The broker can then purchase 480 plans selected by a client. In certain instances, the purchase selected plan and rates step moves it automatically to “Current Plans” in the application. The system will send an e-mail notification to the carrier. Thereafter, in step 485, the broker can decline plans from other carriers and in step 490, close the RFP. In preferred aspects, a closed RFP is automatically saved under the “My Archived RFP” link.

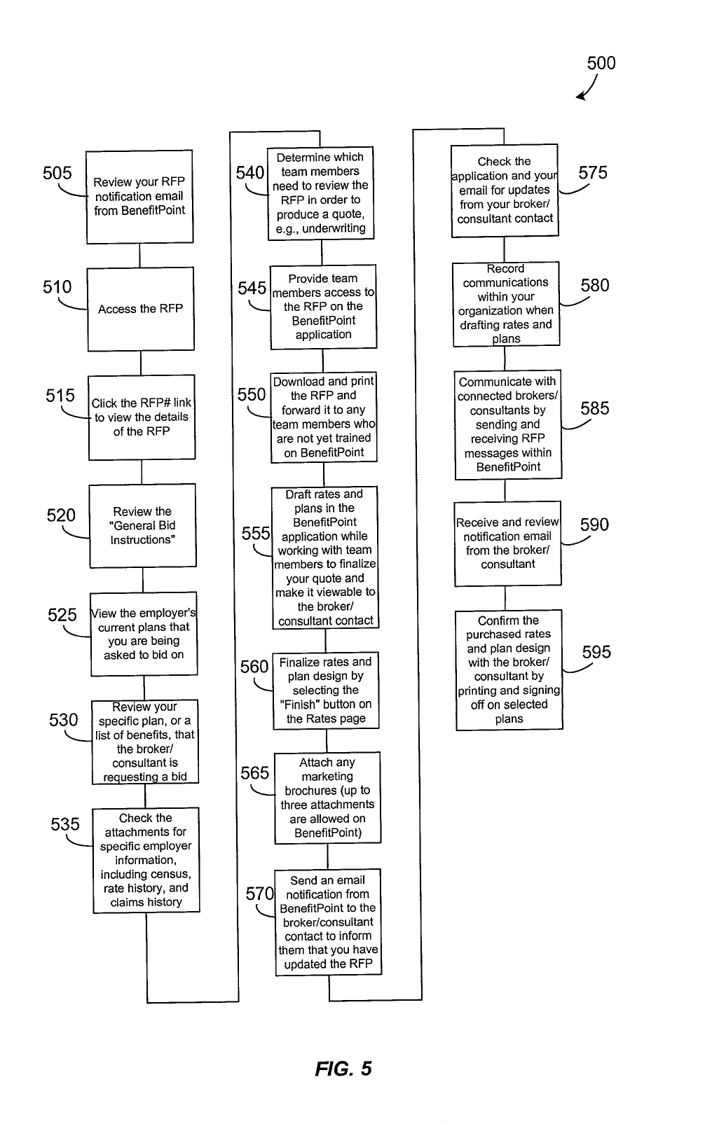

FIG. 5 illustrates a flow diagram 500 representing a RFP checklist for a carrier for one embodiment of the present invention. One of ordinary skill in the art would recognize many other variations, modifications, and alternatives.

In step 505, the carrier can review a RFP notification e-mailed from the system. In certain aspects, it is advantageous to check the due date and effective date. The carrier can then view the broker/consultant contact as well as review the line of coverage that is being requested to quote. Next, in step 510, the RFP is accessed by for example, clicking onto a URL link in the RFP notification e-mail, or logging into the system application via an Internet browser. The carrier can then click on the “My RFPs” link. Various methods are available for locating the RFP. For example, it may be located by the system assigned RFP#, as indicated in for example, the notification e-mail.

In step 515, the RFP# link is clicked on to view the details of the RFP. The carrier can optionally review in step 520 the “General Bid Instructions”. In step 525, the carrier can view the employer's current plans that the carrier is being asked to bid on, by reviewing 530 a specific plan, or a list of benefits, that the broker/consultant is requesting a bid comparison to be done. In certain aspects, the carrier then checks 535 the attachments for specific employer information, including census, rate history, and claims history. In general, current plan information comprises information about the employee benefit insurance plans the employer currently offers to employees.

In step 540, the carrier can determine which team members need to review the RFP in order to produce a quote, e.g., sales, or underwriting, and the like. Preferably, the carriers provide 545 team members access to the RFP on the system application. Optionally, the carrier can forward an RFP to any of the team members who are not yet trained or familiar with the online system. The RFP can be downloaded and printed (550) by selecting the “Print RFP” button or saved to their client computer and emailed as an attachment. In certain aspects, the carrier can draft rates and plans in the system application while working with team members in an iterative process to finalize a quote and then make it viewable to the broker/consultant contact.

In step 560, the rates and plan design can be finalized by selecting the “Finish” button on a web page (e.g., the Rates page). Optionally, the carrier can attach 565 any marketing brochures (e.g., 3 attachments). In step 570, the carrier authorizes an e-mail notification from the system to the broker/consultant contact to inform them of the updated RFP. The carrier then checks 575 the application and e-mail for updates from the broker/consultant contact.

In step 580, the system records communications within the carrier organization when drafting rates and plans. The system allows communications 585 with connected brokers/consultants by sending and receiving RFP messages within the system. In certain preferred aspects, the communications within the system are date and time-stamped and logged.

In step 590, the carrier receives and reviews notification e-mail from the broker/consultant either a plan is purchased or declined. If for example, the broker/consultant purchases a carrier plan(s) for the employer, then the proposal information is automatically moved to the employer's “Current Plans” on the system. If the broker/consultant declines the plan(s), the carrier receives an e-mail notification, if the broker chooses to send one. Finally, the carrier confirms 595 the purchased rates and plan design with the broker/consultant by printing and signing off on selected plans.

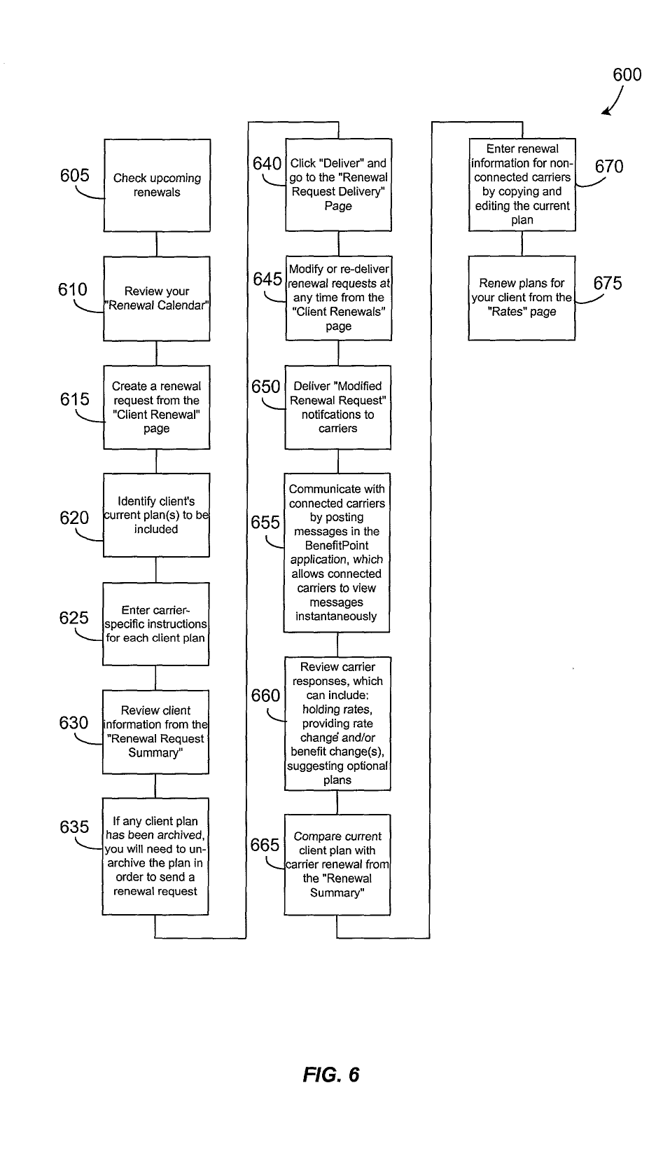

FIG. 6 illustrates a flow diagram 600 representing a renewal checklist for brokers for one embodiment of the present invention. One of ordinary skill in the art would recognize many other variations, modifications, and alternatives.

Advantageously, the systems and methods of the present invention automate the way brokers renew plans for their clients (e.g., employers). Preferably, the brokers and carriers can conduct the entire renewal process online. In step 605, the broker checks upcoming renewals, such as by viewing the list of upcoming renewal requests, which is set up for automatic delivery from the system. In certain aspects, the broker can determine whether to create the renewal delivery and update client information or proceed with the system-generated delivery. The broker can review 610 the “Renewal Calendar”, for example, to view renewals by month or by client. Optionally, the broker can identify if any renewals are overdue. In a preferred aspect, the upcoming renewal requests are flagged (e.g., 74 days before due) prior to system-generated delivery. Moreover, the system generated renewal requests are delivered to carrier contacts that are matched with the addresses on your “My Contacts” list by lines of coverage and market size of plans. In certain aspects, the account team owner for the client will receive a copy of the system-generated renewal request as well.

In step 615, the broker creates a renewal request from the “Client Renewal” page. The broker identifies 620 client's current plan(s) to be included. Thereafter, the broker can enter 625 carrier-specific instructions for each client plan. In step 630, the broker reviews client information from the “Renewal Request Summary”. This can optionally be accomplished by viewing client census. The broker can attach proposals, if appropriate and view “Benefit Summary”, “Plan Info”, and “Rates” for client's current plans. The broker can optionally add any messages for the carrier(s) to view regarding the renewal request. The system allows a broker to create an online questionnaire and add to a renewal for the carrier to answer online. The broker can compare all carrier responses via a comparison tool and incorporate into an employer report.

In step 635, if any client plan has been archived, the broker un-archives the plan in order to send a renewal request. The broker can access the client plan from “Archived Plans”, and change the renewal date to a future date. Thereafter, the broker clicks “Deliver” and goes to the “Renewal Request Delivery” page. Optionally, the broker then selects carrier(s) and plan(s) to deliver and views the “Delivery Confirmation” page once the renewal is delivered from the system. Preferably, the “Delivery History” page maintains a log of all delivery information. In certain aspects, when a renewal is delivered, carrier users receive an e-mail from the system notifying them of the request. In addition, the connected carrier users can click on the URL link to access the renewal on the system application. Non-connected carrier users will receive all renewal information within the e-mail notification and will reply via fax, e-mail, mail or the like.

The broker modifies 645 or re-delivers renewal requests at any time from the “Client Renewals” page. In step 650, the broker delivers “Modified Renewal Request” notifications to carriers and communicates 655 with connected carriers by posting messages in the system application, which allows connected carriers to view messages instantaneously.

The broker reviews 660 carrier responses, which can include, but are not limited to, holding rates, providing rate change and/or benefit change(s) and suggesting optional plans. Preferably, all communications within the systems and methods are date and time-stamped and logged.

The broker compares 665 the client's current plan with carrier renewal from the “Renewal Summary” and enters 670 renewal information for non-connected carriers by copying and editing the current plan. The broker renews 675 plans for clients from the “Rates” page. The broker can renew selected rates, as this will move it automatically to “Group Plans” as a pending plan until the effective date. Thereafter, the broker sends e-mail notification. Preferably, plans are archived past the renewal date. Archived plans can be accessed from the home page.

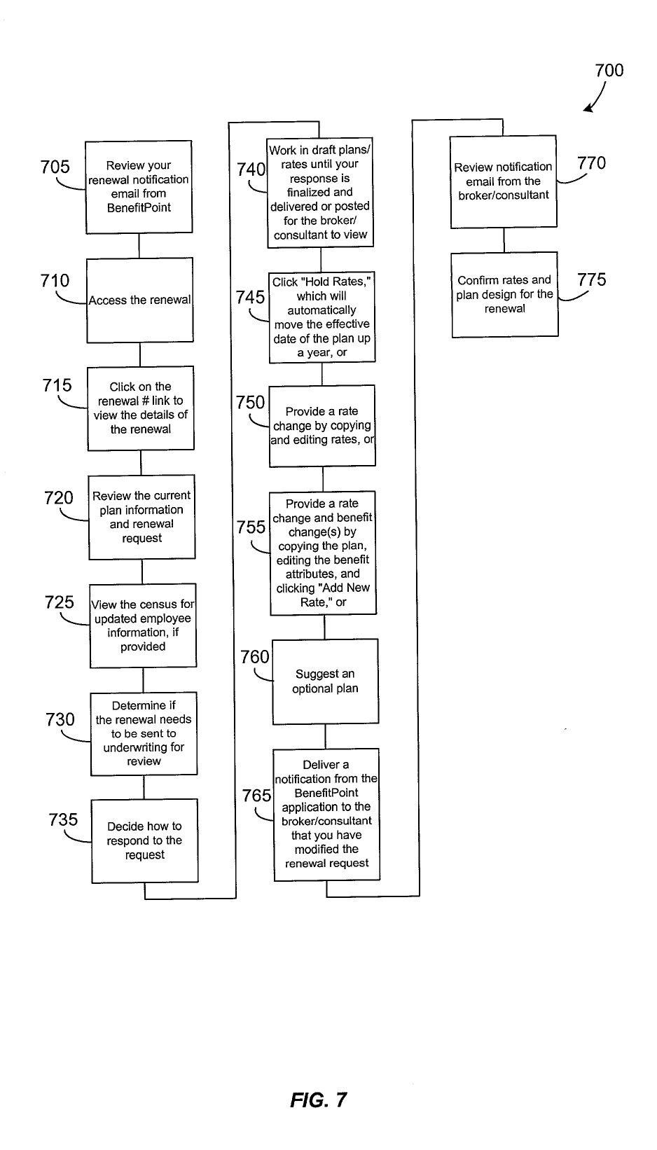

FIG. 7 illustrates a flow diagram 700 representing a renewal checklist for carriers for one embodiment of the present invention. One of ordinary skill in the art would recognize many other variations, modifications, and alternatives. As shown, the system automates the way carriers receive and respond to renewals from brokers. The entire renewal process can be conducted online.

In step 705, the carriers review the renewal notification e-mail from the system. In certain aspects, the carrier checks the due date for response and the renewal date. In addition, the carrier views the broker/consultant contact and reviews client information including the number of lives and line(s) of coverage requested.

The carrier accesses 710 the renewal, by for example, clicking the URL link in the renewal notification e-mail, or logging into the system application via an Internet browser. Preferably, the carrier clicks “My Renewals” link and locates the renewal by its assigned system renewal #, or employer name as indicated in the system notification e-mail. Preferably, renewal requests are generated by either the broker/consultant or the system application based on an automatic submission set by the broker/consultant.

In step 715, the carrier clicks on the renewal # link to view the details of the renewal. The carrier reviews 720 the current plan information and renewal request. This includes, but is not limited to, “Benefit Summary” “Plan Info” (This includes eligibility rules), “Rates”, and “Renewal Messages” posted from the broker/consultant contact. The carrier views 725 the census for updated employee information, if provided. If the carrier needs additional information, the carrier sends the broker/consultant contact an e-mail message from the system application.

In step 730, the carrier determines if the renewal needs to be sent to underwriting for review. The carrier can then decide 735 how to respond to the request. The carrier may choose to work 740 in draft plans/rates until the response is finalized and delivered or posted for the broker/consultant to view. In step 745, the carrier clicks “Hold Rates”, which will automatically move the effective date of the plan up a year, or provide a rate change by copying and editing rates, or provide a rate change 750 and benefit change(s) by copying the plan, editing the benefit attributes, and clicking “Add New Rate”, 755 or the carrier may suggest 760 an optional plan. In this manner, the carrier may wish to search the system Product Library for one or more plans or add the selected plan as an option plan and edit if necessary.

In step 765, the carrier delivers a notification from the system application to the broker/consultant that they have modified the renewal request. Thereafter, in step 770, the carrier reviews the notification e-mail from the broker/consultant and confirms 775 rates and plan design for the renewal.

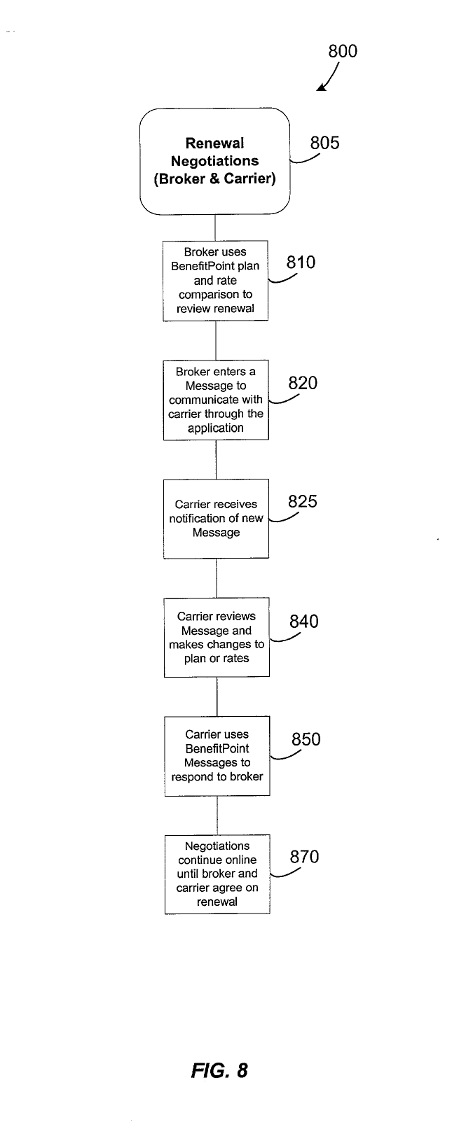

FIG. 8 illustrates a flow diagram 800 representing a negotiation for one embodiment of the present invention. One of ordinary skill in the art would recognize many other variations, modifications, and alternatives. As shown, the system automates the way carriers and brokers negotiate renewals 805. In step 810, the broker uses the system to compare and review plans and rates. The broker can enter 820 a message to communicate with the carrier. In step 825, the carrier receives the notification of the new message. Thereafter, the carrier reviews 840 the message and makes changes to the plan or rates. The carrier then uses the system to respond to the broker 850. Negotiations continue 870 to agreement.

In certain preferred aspects, the systems and methods of the present invention provide an enrollment and benefits administration module coupled to the presale module for providing an employer with a set of employer tools for benefits administration for an employee and for processing a benefit product for the employee. Advantageously, the enrollment and benefits administration module includes functionality for benefits tracking and maintenance performed by the employer's Human Resource (HR) personnel. In certain aspects, the enrollment and benefits administration module includes integration with other departments and functions such as HR, Information Systems and payroll.

The enrollment and benefits administration module provides employers with tools to manage and organize group benefit and employee information. In a preferred aspect, the systems and methods integrate with payroll and other functionalities. The systems and methods of the present invention act as a proxy HR or IS for those employers without an HR or IS. The systems and methods of the present invention stores detailed information relating to the company's benefit program as well as employee records and related data. In addition, the system offers a report writer that can organize and generate census information, carrier billing/reconciliation and a number of standard or custom reports. Moreover, premium and eligibility information can be electronically distributed to carriers, 401 (k) and payroll vendors.

Moreover, in certain aspects, the enrollment and benefits administration module further comprises enrollment functionality. In this manner, the benefit elections and the changes to personal information can be made, and the purchases and other transactions done directly by the employee on their desktop. The systems and methods of the present invention provide enrollment tools that offer ease of use while offering access to additional products and content relating to enrollment and life events. The self-service tools include plan comparison data and provider directory information, and the tools enable employees to update and/or confirm their personal demographic profiles and to make group enrollment and personal insurance selections. Employees access the system not only for periodic open enrollment, (e.g., just once a year), but also on an ongoing basis to change profiles, change doctors, add dependents, ask benefit questions, purchase individual insurance products, change 401(k) allocations, and the like.

As will be apparent to those of skill in the art, in certain preferred embodiments, data flows from the client management and procurement modules downstream to enrollment and benefits administration. This system is especially advantageous, as it enables multiple functionalities with minimum data entry. The ability to enter data only once reduces error and eliminates redundancy making the system very efficient. The systems and methods of the present invention eliminate the redundant data entry, and excessive paper handling and thus increase customer satisfaction and retention.

In certain other aspects, the present system and methods further comprise an eligibility and billing module to allow for the consolidation and production of a single bill for premiums and transmission of eligibility to carriers. Prior to the advent of the present invention, a major problem for employers was the monthly process of having to reconcile bills from multiple vendors. As the present system has rates and eligibility information, it is now possible to provide consolidated billing and eligibility services. In this manner, employers receive one monthly bill and have the option of making payments via Electronic Funds Transfer (EFT).

In preferred aspects, the systems and methods of the present invention provide the production and delivery of a single bill to the employer for all benefits premiums, and the transmission of eligibility data to carriers and providers.

In certain other aspects, the present systems and methods further comprise a worksite-marketing module to enable distribution of an ancillary product. In certain aspects, within the framework of employee self-service for example, the systems and methods offer employees additional products and content relating to enrollment, life events and retirement. These products include, but are not limited to, life insurance, homeowners insurance, auto insurance, personal umbrella liability insurance, an annuity and a mutual fund. For example, the system can include a streaming video ad for an ancillary benefit product. In certain aspects, the employee record includes a demographic profile and a change in the demographic profile prompts or triggers a targeted ad.

In certain other aspects, each time an employee experiences a life event, the systems and methods of the present invention present the employee with information on how that life event changes his/her risk profile and what products are available to address these new needs. For example, new parents can be presented information about life insurance and education trusts, and employees that have moved or purchased a house can be presented with information about homeowners insurance or new mortgages. This cross-selling capability at the time of a relevant life event represents an advantageous target marketing mechanism that is a compelling way to reach a specific demographic population that is ready to buy their products.

More particularly, the systems and methods of the present invention pull demographic data (SIC code, sex, age, zip code) from the database to generate quotes for these financial products. Product offerings will be in the form of for example, banners, triggered at various points when employees access the system, or via e-mail directed to those employees who have just completed enrollment or life event processing. Worksite marketing has many advantages that will lead to adoption rates significantly higher that traditional group voluntary product offerings: greater exposure, greater choice, discounted pricing, brand name carriers, employer endorsement, and more convenient processing and payment.

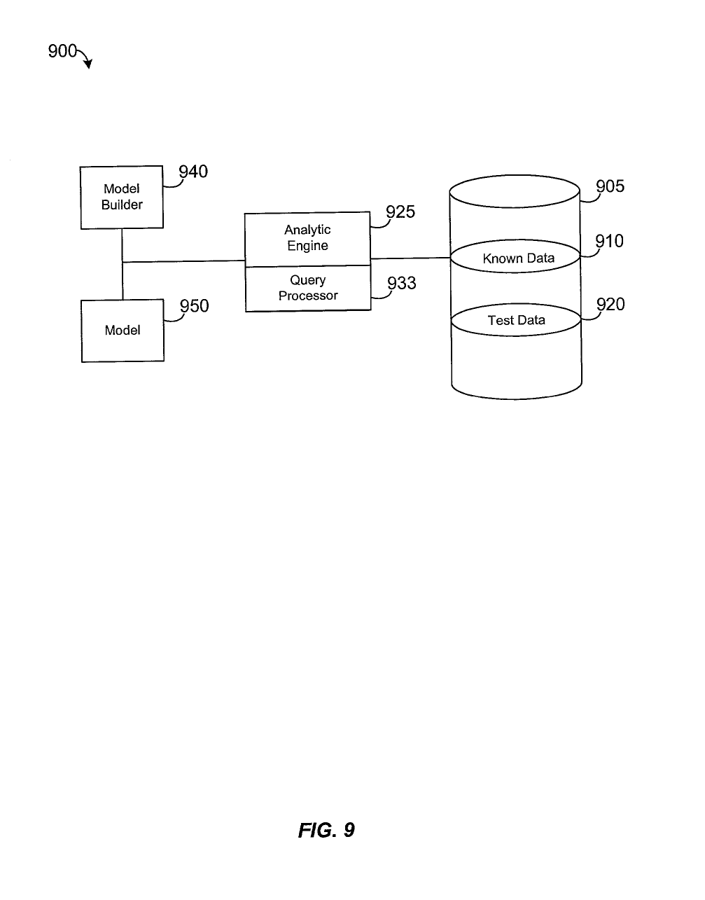

FIG. 9 is an illustration of one embodiment of an analytic module 900 according to the present invention. This diagram is merely an example, which should not limit the scope of the claims herein. One of ordinary skill in the art would recognize many other variations, modifications, and alternatives.

The systems and methods of the present invention provide analysis and selection of stored information in a database 905, similar to database 106 in FIG. 1A. The database can be digital information stored in any digital storage medium, such as conventional random access memory, tape storage, CD-ROM, and the like. Advantageously, the carriers, brokers, and employers have access to key business intelligence through data mining of clean, comprehensive data.

The database can be built using a great variety of information for each component or record of the database. For example, in database 905 where the records correspond to individuals, the individual's age, address, employee ID, employee status and the like, the available information can be used to design targeted marketing campaigns, distribute products more efficiently, quantify acquisition costs, and design specific products and services to meet market needs. Carriers gain a deeper understanding of the competitive environment, as well as how clients purchase and use employee benefits products and services. For example, if a carrier wishes to send out a targeted worksite marketing “mailer”, the carrier would like to know in advance which individuals are likely to respond favorably to the targeted “mailing”. A number of techniques have been developed for manipulating the known fields (i.e., the characteristics recorded in the database, corresponding to name, age, income, and the like) to determine a new characteristic (e.g., field) that is more meaningful. Such techniques include those referred to in the art as “data mining.”

Using the analytics and data mining capabilities of the present invention, brokers and carriers are able to market to targeted audiences. In this manner, they are able to better understand and quantify their acquisition costs, and to design marketable proprietary products and services. Moreover, employers gain a better understanding of the employee benefits market in which they compete for new employees and to retain their current employees.

In one embodiment, FIG. 9 illustrates one way (of a number of ways) of developing a new field for the database 905. A database 905 is provided that includes both known data 910 and test data 920. The known data 910 can be for example, a table (including a number of records) of thoroughly understood training data that is provided to a model builder 940. The model builder 940 can be software running on a general purpose computer. Examples of commercially available packages that can be used for a model builder 940 include, but are not limited to, Enterprise Miner (and standard SAS modeling software found in SAS/Base, SAS/STAT, and the like), available from the SAS Institute (“SAS”) of Cary, N.C.; the SPSS program available from SPSS of Chicago, Ill.; Intelligent Miner available from IBM of Armonk, N.Y.; Darwin, available from Thinking Machines of Burlington, Mass.; Modell, available from Unica of Lincoln, Mass.; NeuralWorks Predict, available from NeuralWare, of Pittsburgh, Pa.; and MineSet, available from Silicon Graphics of Mountain View, Calif. In certain other embodiments, the model builder 940 can also be a custom or semi-custom design for implementing a model, such as a hardware implementation of a neural-network.

The model builder 940 constructs a model 950. The model 950 can be some general method or technique for computing a new value or other parameter based on one or more fields within the records of the known data 910. The model 950 may be, for example, a statistical analysis or mathematical equation for computing a probability (for example, the probability that an employee will respond favorably to an ancillary benefit product), a true/false field, or any other numerical, alphanumeric or other result. The result of the model or new field may be referred to as a “score.” Thereafter, the score can be used to make a decisions before launching the ancillary benefit product.

In a preferred embodiment, an analytics engine 925 is provided. In certain embodiments, the analytics engine 925 is coupled to database 905 and includes a query processor 933. In one particular embodiment, the analytics engine 925 is responsible for both querying the database with respect to elements of the database and for evaluating model scores. The analytics engine 925 can be software running on a general purpose computer. Querying can be performed by the query processor 933. In operation, the query processor 933 begins by receiving a query and comparing the query against the model to generate a score. The analytics engine 925 evaluates the scores of the model and further processes the model scores to produce a temporary table that includes only records satisfying the query element involving the model. This resulting table can then be passed back to the query processor 933 for further irritation if desired. The score is thereafter used to make the decision as to whether a marketing campaign is launched.

While the invention has been described with reference to certain illustrated embodiments this description is not intended to be construed in a limiting sense. For example, the computer platform used to implement the above embodiments include 586 class based computers, Power PC based computers, Digital ALPHA based computers, SunMicrosystems SPARC computers, and the like, computer operating systems may include WINDOWS NT, DOS, MacOs, UNIX, VMS, and the like; programming languages may include C, C++, Pascal, an object-oriented language, HTML, XML, and the like. Various modifications of the illustrated embodiments as well as other embodiments of the invention will become apparent to those persons skilled in the art upon reference to this description.

In addition, a number of the above processes can be separated or combined into hardware, software, or both and the various embodiments described should not be limiting. As will be appreciated by one of skill in the art, the present invention can be embodied as a method, data processing system, or computer program product. Accordingly, the present invention can take the form of an entirely hardware embodiment, an entirely software embodiment or an embodiment combining software and hardware aspects. Furthermore, the present invention can take the form of a computer program product on a computer-usable storage medium having computer-usable program code embodied in the medium. Any suitable computer readable medium can be utilized including hard disks, CD-ROMs, optical storage devices, or magnetic storage devices. It will be understood, therefore that the invention is defined not by the above description, but by the appended claims. All publications, patents, and patent applications cited herein are hereby incorporated by reference for all purposes in their entirety.

What is claimed is:

1. A system for the employee benefits industry, said system comprising:
a client management module for providing a broker with one or more broker tools for generating an employer record and employee record;
a presale module coupled to said client management module for providing said broker with one or more workflow tools, said workflow tools enabling a request for proposal (RFP), a renewal functionality, electronic submission of said RFP to an insurance carrier and receiving a response to said RFP;
an enrollment and benefits administration module coupled to said client management module for providing an employer with a set of employer tools for benefits administration for an employee and for and for processing a benefit product for said employee; and
a system database coupled to said at least one server for storing said employer record and said employee record.

2. The system for the employee benefits industry of claim 1, further comprising an eligibility and billing module coupled to said client management module to allow for the consolidation and production of a single bill for premiums and transmission of eligibility to carriers.

3. The system for the employee benefits industry of claim 1, further comprising a worksite marketing module coupled to said customer module to enable distribution of an ancillary product.

4. The system for the employee benefits industry of claim 1, wherein said renewal functionality allows said broker to organize upcoming plan renewals and to submit an electronic renewal request to an insurance carrier and receive a response to said electronic renewal request.

5. The system for the employee benefits industry of claim 1, wherein said workflow tools comprise benefit plan designs offered by a plurality of insurance carriers.

6. The system for the employee benefits industry of claim 1, wherein said workflow tools comprise a merging tool that merges said response to said RFP into an employer presentation.

7. The system for the employee benefits industry of claim 1, wherein said set of broker tools allows collection, management and data mining of said employer record and RFP and renewal information.

8. The system for the employee benefits industry of claim 1, wherein said set of employer tools allows correlation of said employee with a payroll record, said employee record and a 401(k) record.

9. The system for the employee benefits industry of claim 1, wherein said set of employer tools further comprises a report writer that organizes and generates census information and carrier billing.

10. The system for the employee benefits industry of claim 1, wherein said enrollment module comprises a set of self-service tools.

11. The system for the employee benefits industry of claim 10, wherein said set of self-service tools comprises a plan comparison sheet, a provider directory, and a personal demographic profile.

12. The system for the employee benefits industry of claim 1, further comprising a worksite-marketing module.

13. The system for the employee benefits industry of claim 12, wherein said worksite marketing module offers said employee said benefit product selected from the group consisting of life insurance, disability insurance, long term care insurance, homeowners insurance, auto insurance, personal umbrella liability insurance, an annuity and a mutual fund.

14. The system for the employee benefits industry of claim 13, wherein said worksite marketing module includes a streaming video ad for said benefit product.

15. The system for the employee benefits industry of claim 13, wherein said worksite marketing module includes a link to a carrier.

16. The system for the employee benefits industry of claim 1, wherein said employee record includes a demographic profile.

17. The system for the employee benefits industry of claim 16, wherein a change in said demographic profile will prompt said worksite marketing module.

18. The system for the employee benefits industry of claim 1, wherein said billing module reconciles payments from a plurality of insurance carriers.

19. The system for the employee benefits industry of claim 1, wherein said billing module allows an employee to pay individual premiums for certain worksite products.

20. The system for the employee benefits industry of claim 1, wherein said benefit product is selected from the group consisting of medical insurance, dental insurance, vision insurance, life insurance, std insurance, LTD insurance, death benefits, term life insurance, workers compensation, a section 125 plan, whole life insurance, variable life insurance, annuities, mutual funds, IRA, travel accident and accidental death and dismemberment, employee assistance programs, individual homeowner's insurance, renter's insurance, auto insurance, umbrella liability insurance, health insurance, non-qualified retirement plans, and 401(k) plan.

21. The system for the employee benefits industry of claim 1, wherein said networked environment is selected from the group consisting of a worldwide computer network, the Internet, a wide area network, a local area network, and an intranet.

22. A method for procuring a benefit product in a networked environment, said method comprising:
providing a broker with a set of workflow tools enabling a request for quote (RFP) of said benefit product to an insurance carrier and receiving a response from said insurance carrier of said RFP;
providing an employer with a set of employer tools for administration of said benefit product for an employee; and
enrolling said employee in said benefit product offered by said insurance carrier, thereby procuring said benefit product in a networked environment.

23. The method for procuring a benefit product of claim 22, wherein said workflow tools comprise benefit plan designs offered by a plurality of insurance carriers.

24. The method for procuring a benefit product of claim 22, wherein said workflow tools comprise a merging tool that merges said response into an employer presentation.

25. The method for procuring a benefit product of claim 22, wherein said set of workflow tools further comprises a renewal functionality which allows said broker to organize upcoming plan renewals and submit an electronic renewal request to an insurance carrier and receive a response to said electronic renewal request.

26. The method for procuring a benefit product of claim 22, further comprising real-time quoting.

27. The method for procuring a benefit product of claim 22, wherein said set of employer tools allows correlation of said employee with a payroll record, an employee record and a 401(k) record.

28. The method for procuring a benefit product of claim 22, wherein said set of employer tools comprises a report writer that organizes and generates census information and insurance carrier billing.

29. The method for procuring a benefit product of claim 22, wherein said employee enrolls using a set of self-service tools.

30. The method for procuring a benefit product of claim 29, wherein said set of self-service tools comprises a plan comparison sheet, a provider directory, and a personal demographic profile.

31. The method for procuring a benefit product of claim 22, wherein said benefit product is selected from the group consisting of medical insurance, dental insurance, vision insurance, life insurance, std insurance, LTD insurance, death benefits, term life insurance, workers compensation, a section 125 plan, whole life insurance, variable life insurance, annuities, mutual funds, IRA, travel accident and accidental death and dismemberment, employee assistance programs, individual homeowner's insurance, renter's insurance, auto insurance, umbrella liability insurance, health insurance, non-qualified retirement plans, and 401(k) plan.

32. The method for procuring a benefit product of claim 22, wherein said networked environment is selected from the group consisting of a worldwide computer network, the Internet, a wide area network, a local area network, and an intranet.
